(19) United States
(12) Patent Application Publication
(10) Pub. No.: US 2010/0300279 A1
(43) Pub. Date: Dec. 2, 2010

(54) Point Of Use Actuator

(76) Inventors: George Kadlicko, Rockford, IL (US); Wade Stone, Rockford, IL (US)

Correspondence Address: ST. ONGE STEWARD JOHNSTON & REENS, LLC, 986 BEDFORD STREET, STAMFORD, CT, 06905-5619, US

(21) Appl. No.: 12/476,795

(22) Filed: Jun. 2, 2009

(51) Int. Cl. F15B 13/02; F15B 1/26

(52) U.S. Cl. 91/361; 92/142

(57) ABSTRACT

A hydraulic actuator system designed to inwardly contain major portions of its control system. The system includes a unique non-vented and air tight sealed reservoir with expandable bladder. This inward control system and non-vented reservoir optimize space saving advantages and eliminate the need for external elements typically used in a hydraulic system, while extending fluid life, reducing cavitation and fluid oxidation, and increasing performance in the hydraulic system. The system configurations can work for both a single or dual acting linear actuator and further can involve a motor, hydraulic pump, and electro-hydraulic valve circuit used to control fluid throughout the system.

### FIELD OF THE INVENTION

The present invention relates to an improved hydraulic system for single and dual acting linear actuators if appropriately configured. More particularly, the invention is a hydraulic system designed to inwardly contain major portions of its control system. The invention further includes a unique non-vented and air tight sealed reservoir with expandable/retractable bladder. This inward control system and non-vented reservoir optimize, such as plumbing, space saving advantages and eliminates the need for external elements typically used in a hydraulic system, while extending fluid life by preventing cavitation and fluid oxidation in the hydraulic system.

### BACKGROUND OF THE INVENTION

Hydraulic systems are generally made up of various components and assemblies that are externally plumbed together. In the process of assembly of hydraulic systems, the potential for challenges may be presented due to tight space constraints, degradation, and damage from mechanical or human movements.

Hydraulic systems suffer from assemblies that consume too much space, or have their plumbing damaged, which can result in leaking hydraulic fluids. Plumbing damage may cause various safety and environmental issues. Plumbing damage can also reduce system performance from flow restrictions, and can cause pressure differentials throughout the hydraulic system. This may result in a less efficient hydraulic system.

Sizing and orientation of plumbing components may be selected to minimize flow restrictions and to avoid pump cavitation.

In hydraulic systems, there are two types of linear actuators that can be used. Dual acting linear actuators rely upon a hydraulic pump to both extend and retract the linear actuator. These dual acting linear actuators allow fluid to enter on both sides of the piston, allowing either extension or retraction. Single acting linear actuators are actuators that rely upon a hydraulic pump for extension, but rely upon gravity for retraction. Both types of linear actuators are sized with consideration of system pressures, speed and force.

To use these linear actuators, a motor transmits torque output to the pump, enabling the pump to work and to displace fluid located in the system. The application of this fluid to a linear actuator causes the actuator's inwardly-contained piston to move within the body of the cylinder. This transmits force and creates movement. As a result, the piston rod attached to the piston will either extend from, or retract into the actuator to cause the desired movement of the member(s) attached to the hydraulic system.

Various hydraulic systems have been designed to incorporate linear actuators. These systems include electro-hydraulic valve circuits, which function to control hydraulic systems via electronics. The commonly called “lift-hold-lower” system describes the primary functions of the actuator throughout a work cycle, and is a common valve circuit for single acting linear actuators. Pallet trucks, forklifts, auto hoists, lift tables, truck tail gates, and aerial lifts may use this type of circuit. These examples generally require power to extend (lift), hold in place (hold), and enable gravity assisted lowering (lower).

In a “lift-hold-lower” system, lift or extension occurs as a pump displaces fluid to fill one side of the linear actuator. Lift speed may be dependent upon motor speed, pump displacement, actuator volumes, load factors, piston/bore size, annulus area, maximum pressure regulation, system efficiencies, atmospheric conditions, and possible mechanical linkage factors, as well as other factors. In this system, a solenoid valve controls and blocks fluid flow to the reservoir. In a first position, the solenoid valve allows fluid flow in only one direction to prevent reverse flow and resulting positional changes that inhibit holding ability and extension. In a second position, the valve allows fluid flow in the opposite direction, as the actuator empties or retracts. It is understood that either normally open or normally closed solenoid valves be used.

In a “lift-hold-lower” configuration, the actuator can be stopped at any time throughout extension or retraction and is able to hold its position. Position is held by the solenoid valve, which blocks fluid from returning to the reservoir. A check valve prevents fluid from entering the pump outlet.

In a “lift-hold-lower” configuration, lowering or retraction is allowed when the motor is not functioning and the solenoid valve is shifted to a position to allow fluid back to the reservoir. Retraction is gravity dependent for a single acting linear actuator. Speed may be commonly controlled with a metering device to reduce the flow rate of the fluid.

In “lift-hold-lower” and/or “power extend-power retract” configurations, maximum system pressure is regulated by use of a relief valve that senses fluid pressure at the pump outlet. As pressure increases, force transmission overcomes an opposing spring force and the valve opens. Fluid is vented to an area of lower pressure, such as the reservoir or pump inlet. The relief valve will open if pressure to lift a load is within or higher than the maximum allowed pressure of the relief valve. If adjusted properly, the relief valve should not open until full actuator extension has been accomplished.

For dual acting linear actuators, a common electro-hydraulic valve circuit is termed a “power extend-power retract” circuit, describing the method and linear actuator functionality for a work cycle. Devices that utilize this circuit are not dependant on gravity to assist in lowering or retracting the actuator. Device examples often orient the linear actuator in a position that prevents gravity to be considered for retraction, have retraction speed requirements that exceed gravity dependency, or may not have an adequate load weight to assist gravity dependency. Linear actuators used for clamping, presses, or near horizontal movements are generally dual acting.

In a “power extend-power retract” circuit, extension occurs as a pump displaces fluid to fill one side of the linear actuator and retraction occurs as displaced fluid fills the other side. Extension and retraction speeds are dependent upon motor speed, pump displacement, actuator volumes, load factors, piston/bore size, annulus area, maximum pressure regulation, system efficiencies, atmospheric conditions, and possible mechanical linkage factors, as well as other factors. A solenoid valve is commonly used and allows fluid redirection as it is displaced to and from the linear actuator, utilizing a common pump supply. A bi-rotational electric motor is a common approach that eliminates the need for a solenoid control valve, but this approach requires a valve assisted changing inlet arrangement for changing pump rotation.

For load holding, in a “power extend-power retract” circuit, one or two valves are commonly used. These types of valves allow free flow in one direction as fluid is displaced to the linear actuator. Flow in the opposite direction, out of the linear actuator, is prevented, unless there is an adequate pressure applied from the opposite side of the cylinder to assist in the opening of the valve.

Load holding, in a “power extend-power retract” circuit, can also be done using a counter balance valve and is generally used when gravity is a factor that affects speed control. This type of valve provides a positive seal, is normally closed, and requires a pilot pressure to open. Pilot pressure is taken off of the same side of the linear actuator and speed is metered.

A metering device commonly controls speed by changing flow rate. The metering device can be a fixed orifice, adjustable orifice, or a changing orifice that is pressure compensated for a relatively constant passing flow rate, regardless of changes in pressure. Pressure changes during retraction are attributed to load forces that experience friction or angular position changes with respect to a pivot, gravitation pull, and are affected by various other mechanical inefficiencies. A proportional type solenoid control valve can also be used. Metered speed control is not always a requirement, but often used to avoid safety related issues.

In both “lift-hold-lower” and “power extend-power retract” circuits used for single and dual linear actuators, long flexible hoses and/or pipes may be used to connect together the various elements of the system, namely the control valve, cylinder, pump and reservoir.

When the pump, reservoir, valves and hydraulic cylinders are connected together, the end result may be a large number of hoses, fittings, pipes and valves located in damage-prone areas. External hoses consume space and are susceptible to damage when in areas where mechanical or human movements occur. These components may be difficult and/or expensive to replace. Not only are the hoses susceptible to being punctured, but they may be damaged through environmental degradation.

Furthermore, these prior art systems that include hoses and/or pipes may have leakage problems, which can cause environmental, safety, and maintenance issues. Connecting elements can also leak.

External pipes and/or hoses may tend to increase flow restrictions that cause pressure differentials and reduce system efficiency.

Furthermore, problems with flow restrictions in a hydraulic system are exacerbated as the fluid becomes more viscous, e.g. as temperature falls.

Furthermore, in both “lift-hold-lower” and “power extend-power retract” systems, the reservoir is commonly vented to atmosphere to prevent a vacuum as fluid is displaced by the pump to one or more system actuators. Displaced fluid in the reservoir is typically replaced by air in prior art systems.

Venting to atmosphere in hydraulic systems can contribute to 1) aerated fluid; 2) ingress of foreign contaminates that cause environmental and maintenance related problems; 3) fluid oxidation with resulting generated contaminates; and 4) moisture collection in a reservoir with resulting contaminates.

Aerated fluid attributes to cavitation effects within a pump with resulting component damage and generated contaminates. Water attributes to additional oxidation of certain reservoir and system component materials with resulting generated contaminants. Contaminates can present several performance related issues for a hydraulic system comprising of components that move within tight clearances and incorporate small passages. For long term functional success of the hydraulic system, it is crucial to maintain fluid cleanliness.

Furthermore, prior art designs of hydraulic systems contain limitations whereby orientation of hydraulic power units with vented reservoirs must ensure that the pump inlet remains submerged below the oil level in order to prevent cavitation. If a power unit with an exposed vented reservoir is mounted directly to an actuator, it can create additional space demands to ensure proper clearances, reservoir venting, and pump inlet position, as the actuator may require axial movements.

What is desired therefore is to provide a hydraulic system that reduces the need for external hoses that may be susceptible to damage and leaks, resulting in safety issues. It is further desirable to develop a hydraulic system that saves space by integration of components. It is further desired to provide a system with a non-vented reservoir that efficiently promotes these advantages while also providing pressure and speed controls. It is further desired to provide hydraulic systems having a pump inlet remains submerged below the oil level to reduce cavitation. It is further desirable to provide a hydraulic system that extends fluid life.

### SUMMARY OF THE INVENTION

Accordingly, it is an object of the present invention to provide a hydraulic system that eliminates the need for external hoses that are susceptible to damage and leaks. It is a further object of the invention to provide a hydraulic system that efficiently contains space saving advantages from the integration of components. It is an object of the invention to provide a hydraulic system that integrates the components of a hydraulic system and actuator. It is yet a further object of this invention to provide a hydraulic system with a non-vented reservoir. It is still another object of the invention to provide a hydraulic system with an air tight sealed reservoir with expandable bladder. It is a yet another object of this invention to orient hydraulic system without worrying about cavitation.

These and other objectives are achieved by providing a hydraulic system comprising: a hydraulic actuator capable of moving under drive from fluid, a pump mounted to the actuator for moving the fluid, a motor driving the pump, and a non-vented reservoir that provides fluid to move the actuator. The hydraulic actuator is being moved in a direction parallel to its longitudinal axis X.

In a preferred embodiment, the reservoir is sealed air tight with combined volumes of said actuator and an expandable bladder surrounding said actuator. This expandable bladder can have a cover around it. The bladder expands and contracts to maintain pressure in the reservoir. The bladder prevents reservoir pressure from increasing during volume changes that result from thermal changes.

When the hydraulic actuator expands, it does so by having fluid flow into the actuator. When the hydraulic actuator retracts in a “lift-hold-lower” circuit, the present invention allows it to do so by gravity.

Furthermore, a preferred embodiment has the hydraulic actuator, pump, motor, and reservoir contained in an air tight sealed housing. This air tight housing allows no air to enter the system, which could contribute to fluid oxidation or cavitation.

The hydraulic system can also have the reservoir directly connected to the pump inlet. This embodiment can eliminate oxidation of fluid. Furthermore, cavitation may be reduced by the present invention, as the reservoir is non-vented.

The invention further comprises a control valve circuit which controls the flow of fluid throughout the hydraulic system. The control valve circuit can contain a combination of a solenoid, relief, check, and/or other types of valves.

The hydraulic system is also designed such that it is not dependent upon pump inlet position or external plumbing position. This is due to the reservoir sealed air tight, and lack of air in the system, offering increased flexibility in the design of the present invention.

In preferred embodiments of the invention, there is a pump shaft seal vented to the reservoir. The pump shaft seal is vented to the reservoir and susceptible to symptoms of failure if the pressure is not maintained.

In a preferred embodiment, the hydraulic system further comprises a metering device that controls the flow of fluid in the actuator. This metering device can be a fixed or adjustable orifice that may be pressure compensated or part of a proportional valve design.

The system further has fluid and in a preferred embodiment the total volume of hydraulic fluid is greater than the volume required to extend the actuator. This volume of fluid is sufficient to prevent the bladder from collapsing before or after full extension has occurred, and is not over-filled when the actuator is fully retracted.

There can be a relief valve present, so when the actuator is fully extended, the fluid pressure opens the relief valve. This limits the pressure in the system and is a safety feature that reduces incidence of adverse effects.

After assembly, filling procedures, and relief valve adjustment, the system requires only mounting and electrical connections.

In an embodiment of the invention, the hydraulic system comprises a first housing comprising a motor, a pump connected to the motor, a second housing comprising an actuator, a reservoir containing hydraulic fluid, and a control valve circuit, wherein the reservoir is connected to the actuator via the control valve circuit, and wherein the actuator is capable of moving in a direction parallel to the longitudinal axis of the second housing, and a third housing connecting at least a portion of the first and second housings.

The hydraulic system also may preferably have the first housing parallel to the second housing. The reservoir is also preferably non-vented. The reservoir is sealed air tight with combined volumes of the actuator and an expandable bladder surrounding the actuator. Also in preferred embodiments, the first housing and second housing are both cylindrically shaped.

Furthermore, there is a control valve circuit that controls fluid flow in the hydraulic system. The pump displaces the fluid from the reservoir through the control valve circuit and into the actuator. When the fluid enters the actuator, it causes the actuator to move, thus providing a force and allowing an object to be moved.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a front cross-sectional view of the hydraulic system in accordance with the invention taken along plane 1-1 from FIG. 4;

FIG. 2 is an enlarged detail view of a portion of the system of FIG. 1;

FIG. 3 is an enlarged detail view of a portion of the system of FIG. 1;

FIG. 4 is a frontal elevation view of the hydraulic system of FIG. 1;

FIG. 5 is a top plane view of the hydraulic system of FIG. 1;

FIG. 6 is a left end elevation view of the hydraulic system of FIG. 1;

FIG. 7 is an exploded isometric view of the hydraulic system of FIG. 1 showing the plane cross-section of FIG. 1;

FIG. 8 is a top sectional view along plane 8-8 as shown in FIG. 4 of the hydraulic system of FIG. 1 showing the control valve circuit;

FIG. 9 is a back election view of the hydraulic system of FIG. 1 showing a metering device cavity;

FIG. 10 is a circuit diagram for a lift-hold-lower circuit with a pressure compensated orifice for metering of the invention in FIG. 1;

FIG. 11 is a circuit diagram for a lift-hold-lower circuit with a fixed orifice for metering of the invention in FIG. 1;

FIG. 12 is circuit diagram for a lift-hold-lower circuit with a proportional solenoid controlled valve for metering of the invention in FIG. 1;

FIG. 13 is a circuit diagram for a power extend-power retract circuit with a uni-rotational motor;

FIG. 14 is a circuit diagram for a power extend-power retract circuit with a uni-rotational motor;

FIG. 15 is a circuit diagram for a power extend-power retract circuit with a uni-rotational motor and proportional solenoid controlled valve for metering;

FIG. 16 is a circuit diagram for a power extend-power retract circuit with a bi-rotational motor.

### DETAILED DESCRIPTION OF THE INVENTION

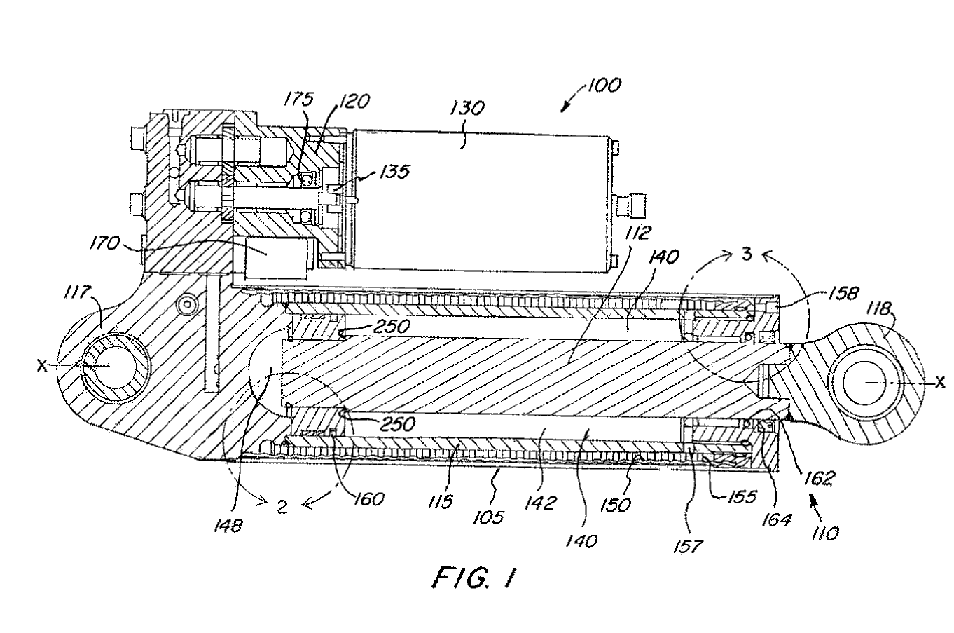

Referring to FIG. 1, a hydraulic system 100 in accordance with the present invention is shown. Hydraulic system 100 eliminates the need for external hoses that are susceptible to damage and leaks. System 100 efficiently contains space saving advantages from the integration of components.

The hydraulic system comprises an actuator 110 capable of moving under drive from hydraulic fluid 1000 (not shown), a pump 120 mounted to the actuator 110 for moving fluid 1000, a motor 130 driving the pump 120, and a non-vented reservoir 140 that provides fluid 1000 to extend the actuator 110. The actuator 110 contains an actuator rod 112, actuator tube 115, and two mounting provisions 117 and 118. When the actuator is actuated, the actuator rod 112 moves in an axial direction parallel to the longitudinal axis X of the actuator 110.

The rod side volume of the reservoir 140 is shown as 142. The bladder volume 155 is also next to volume of reservoir 140. Thus, some of the volume of the reservoir 140 surrounds the actuator rod 112 and some does not. The reservoir 140 is part of the actuator 110. Volume on the rod side 142 and bladder volume 155 is added to the volume 148 on the cap of actuator 110 as needed.

Furthermore, the system 100 may be sealed air tight with combined volumes of said actuator 110 and an expandable bladder 150 surrounding said actuator. In certain embodiments a cover 105 is shown surrounding the bladder 150. The bladder 150 is used to maintain pressure in the reservoir 140. The bladder 150 is capable of expanding and contracting as such in order to regulate the pressure inside the reservoir 140. A fluid passage 157 between the rod end volume 142 of the reservoir 140 and the bladder volume 155 is also shown. This is how the bladder 150 is connected to the reservoir 140.

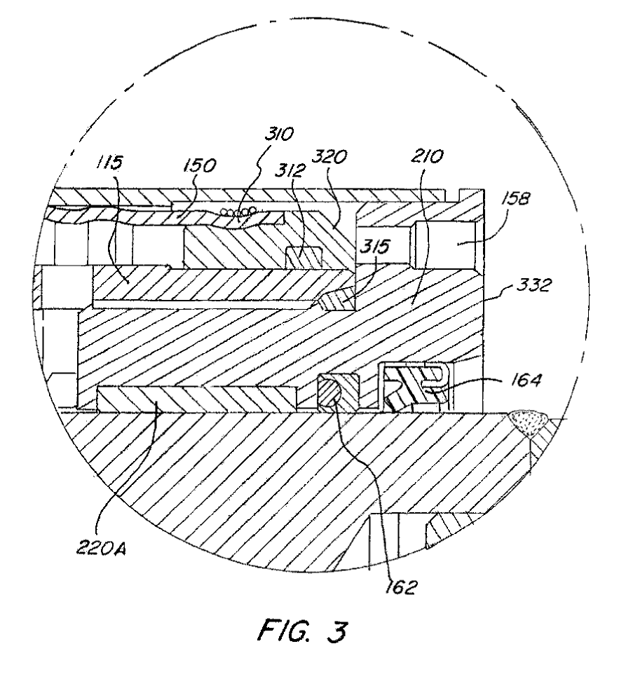

An atmospheric vent 158 (also shown in FIG. 3) allows expansion and contraction of the bladder 150.

FIG. 1 also shows sealing elements including a dynamic piston seal 160, main rod seal 162, and rod wiper seal 164. These sealing elements and others keep the actuator system 100 and others sealed air tight, as well as keep the actuator system 100 sealed when the actuator 110 moves.

FIG. 1 also shows solenoid valve 170 and a pump shaft seal 175. The pump shaft seal 175 may be vented to the reservoir 140.

The engaged drive/transmission features 135 are also shown in relation to the motor 130 in this portion of FIG. 1.

The actuator system 100 can use various types of pumps 120. The choice of pump 120 is dependent on application performance demands, actuator size, selection of motor, loads, envelope, environment, and cost.

Types of pumps 120 used can include, but are not limited to: fixed displacement, single or multiple section external gear pump with fixed or pressure balanced gear side clearances; variable displacement, axial or radial piston pumps; and variable displacement, balanced or unbalanced vane pumps.

Motor 130 provides torque transmission as the prime mover of a hydraulic pump 120. The motor 130 is selected based upon considerations for rotation, voltage, frequency, phase, enclosures, torque demand, horsepower or wattage consumption, duty cycle and thermal limitations, flux arrangement, mounting, drive configuration, size, materials, environment, and cost.

Motors 130 can be provided as a direct current motor with either permanent magnet or wound field, a direct current motor with or without brushes, an alternating current induction motor that is either single or polyphase, an alternating or direct current gear motor with either internal or external gear reducer, an alternating of direct current servo motor, and an alternating or direct current motor with single or bi-rotational torque output.

The hydraulic system 100 shown in FIG. 1 further involves an actuator 110 which can retract either via gravity or via fluid 1000. This amounts to the hydraulic actuator 110 being either of a single or dual acting linear configuration. Furthermore, the fluid 1000 is displaced by the pump 120.

Also shown in FIG. 1 are the hydraulic actuator 110, pump 120, motor 130, and reservoir 140. Housing 105 protects bladder 150.

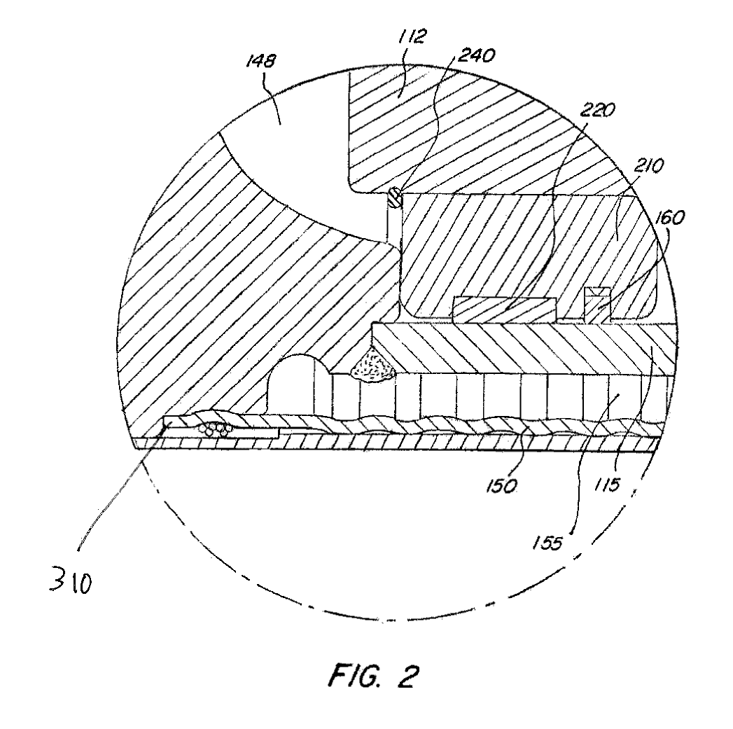

FIG. 2 is a detailed view of the bladder 150 and bladder volume 155 used in conjunction with a piston 210, wear ring 220, piston seal 160, and retaining ring 240. When fluid enters 148, fluid pressure acting against piston 210 causes the actuator rod 112 to move.

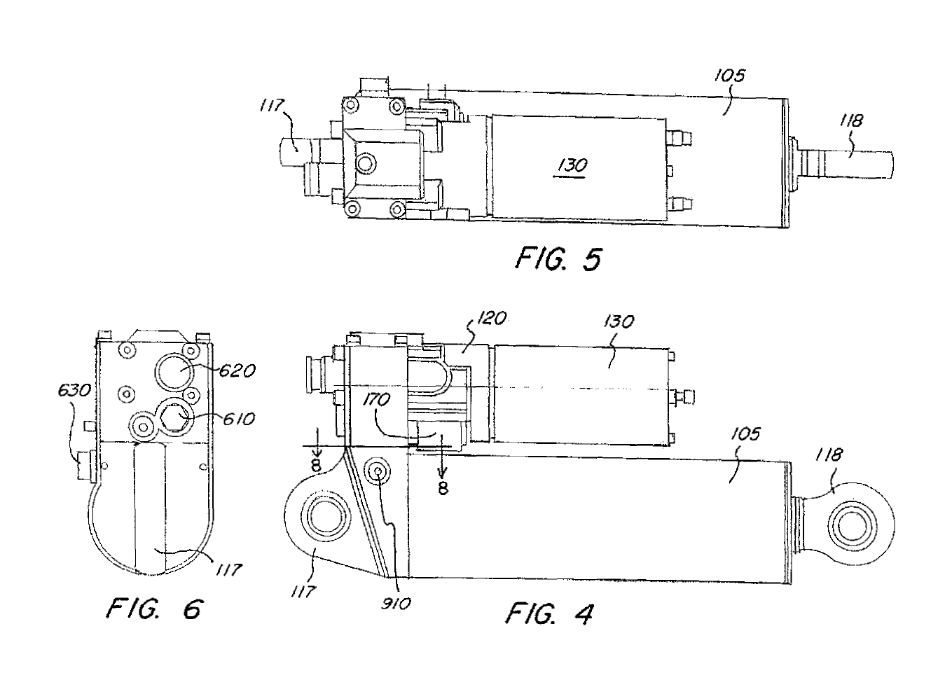

FIG. 3 is a detailed view of another section of bladder 150. Here one can see static sealing elements 310, 312, and 315. The pilot ring 320 and end-head 330 are also shown. FIGS. 4-6 show a side view, top view and rear view of the hydraulic actuator system 100. These figures will be used to further describe the hydraulic actuator system 100.

The actuator end-head 117 and actuator tube 115 are welded together. The actuator tube 115 provides a threaded end, surfaces for static seal elements 312, 315, and passages to the bladder 150. Bladder material is flexible, fluid compatible, thermally stable, and capable of providing a static seal at its end connections.

The actuator end-head 117 and a pilot ring 320 both provide similar surface geometry for securing the bladder 150 with a minor stretch fit. Bonding compounds and/or wraps are optional, but can be used to assist mounting retention and/or integrity of static seal 310 at both ends.

The pilot ring 320 contains and applies a static seal 312 against the actuator tube 115 (also shown in FIG. 1). The bladder 150 is covered or shielded with a cylindrical tube 105, piloted and secured on the actuator end-head 117. The end-cap 332 threads into the actuator tube 115 and applies a static seal, while it pilots and retains the cylindrical cover 105, houses a wear ring 220, main rod seal 162 and rod wiper seal 164, provides an atmospheric vent 158 to enable bladder 150 expansion and contraction, and can incorporate provisions for a stop tube or cushion.

In certain embodiments, the hydraulic pump 120 is bolted to the end-head 117 and retains static seals (not shown) around passage interfaces. Specific passages (not shown) connect the reservoir 140 to the pump inlet (not shown), bearing vents (not shown), the pump shaft seal vent (not shown), and the relief valve exhaust (not shown). Reservoir volumes 142 and 155 provide a low pressure area for the relief valve exhaust, shaft seal venting, and bearing vents. Specific passages connect various valves of an electro-hydraulic circuit integrated within the pump 120 and actuator end-head 117 for controlling extension, position, retraction, and system pressure. Specific passages connect the pump outlet (not shown) to the actuator 110. The motor 130 is mounted directly to the pump 120.

The piston assembly 321 is mounted on the actuator rod 112 and retained against a retaining shoulder using a retaining ring 240. Diameter clearance between the piston 210 and actuator rod 112 is minimized with a sealing compound. Applied surface forces between the piston 210 and actuator rod 112 occur at the retaining shoulder 250 for “lift-hold-lower” configurations.

The reservoir 140 can reduce oxidation of hydraulic fluid, thereby extending fluid life. Air tight sealing of the reservoir and lack of system air reduces contaminate ingression and cavitation, and allows for multiple orientation possibilities that are not dependant on pump inlet position or external plumbing constraints.

To extend the actuator in the “lift-hold-lower” configuration, motor 130 transmits torque to the pump 120, enabling fluid 1000 displacement from the reservoir 140. During extension, fluid 1000 travels from the decreasing actuator volume to the bladder 150, from the bladder 150 to the pump inlet, through the pump 120, out of the pump 120 and through a check valve 610, out of the check valve 610 and through a solenoid valve 170, out of the solenoid valve 170 and into the actuator 110. The check valve 610 and relief valve 620 are shown in FIG. 6.

At full extension in the “lift-hold-lower” configuration, fluid becomes restricted and pressure builds, the relief valve 620 can open, and the motor 130 is stopped. When the actuator 110 needs to be positioned, the motor 130 is stopped and solenoid valve 170 is shifted accordingly to prevent fluid from leaving the linear actuator 110. The actuator can also be stopped during retraction by shifting solenoid valve 170 accordingly.

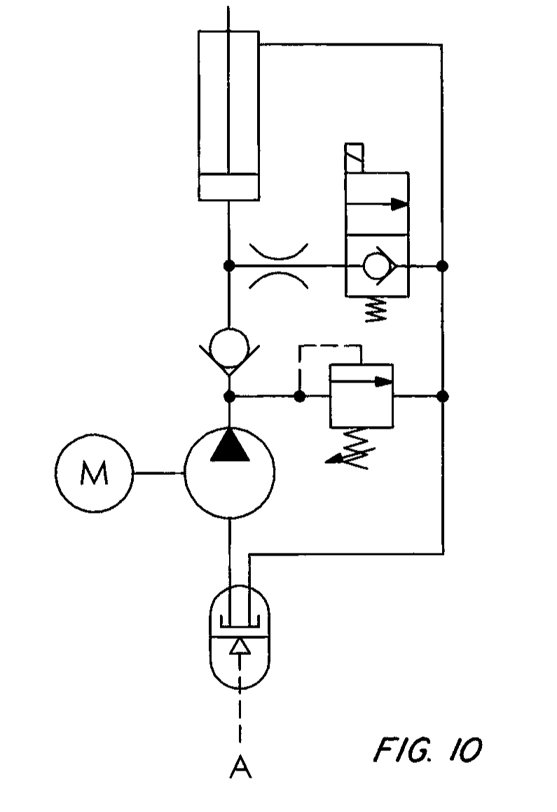

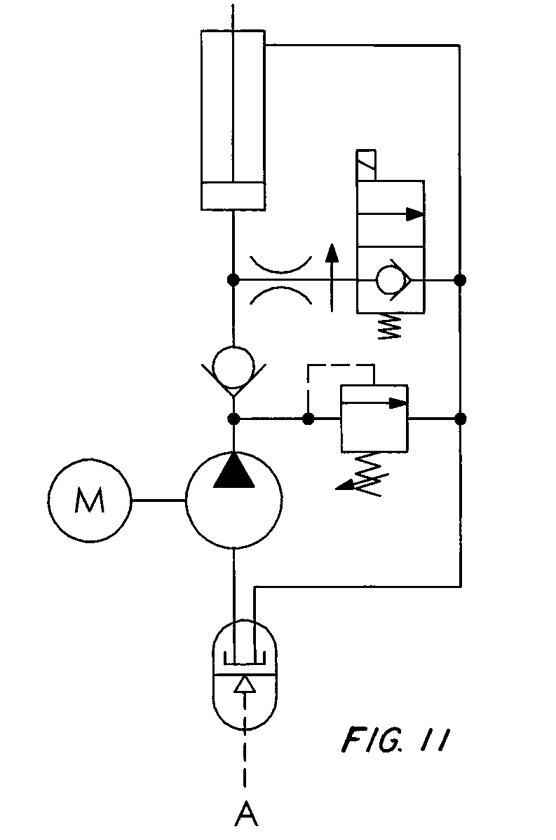

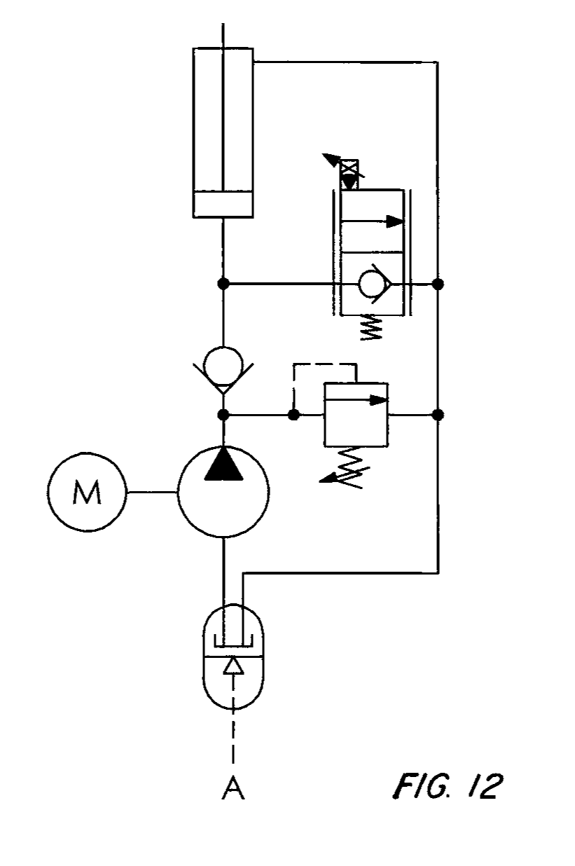

Three different “lift-hold-lower” configurations are shown in FIGS. 10-12, respectively. In a “lift-hold-lower” configuration, when the actuator 110 retracts, gravity assists and the motor 130 is off.

In FIG. 10, a “lift-hold-lower” configuration is shown with a fixed orifice for metering.

FIG. 11 shows a “lift-hold-lower” configuration with a pressure compensated orifice for metering.

FIG. 12 shows a “lift-hold-lower” configuration with proportional solenoid controlled valve for metering.

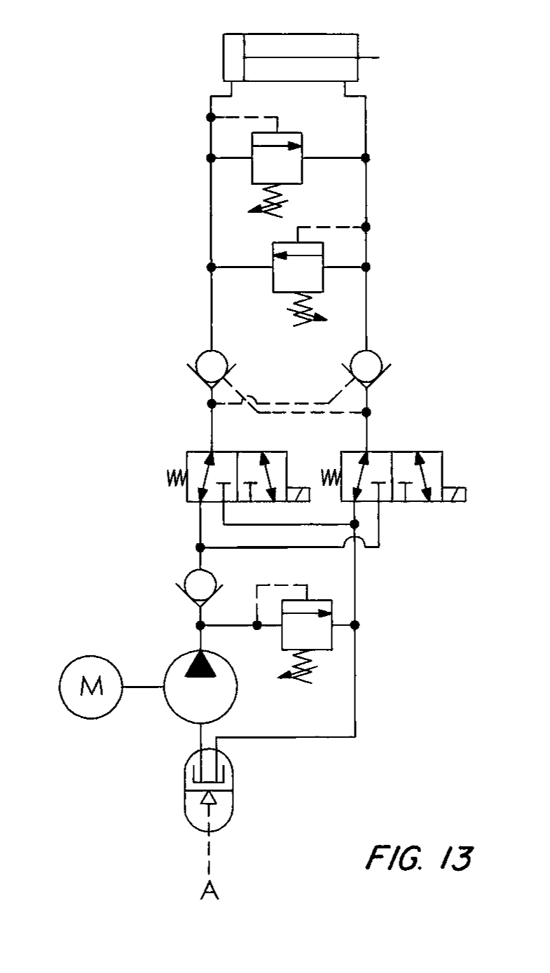

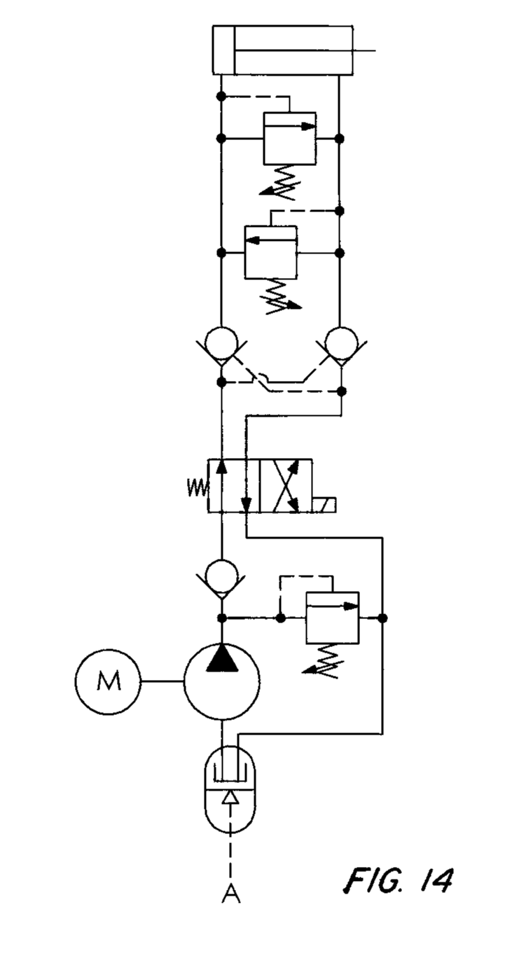

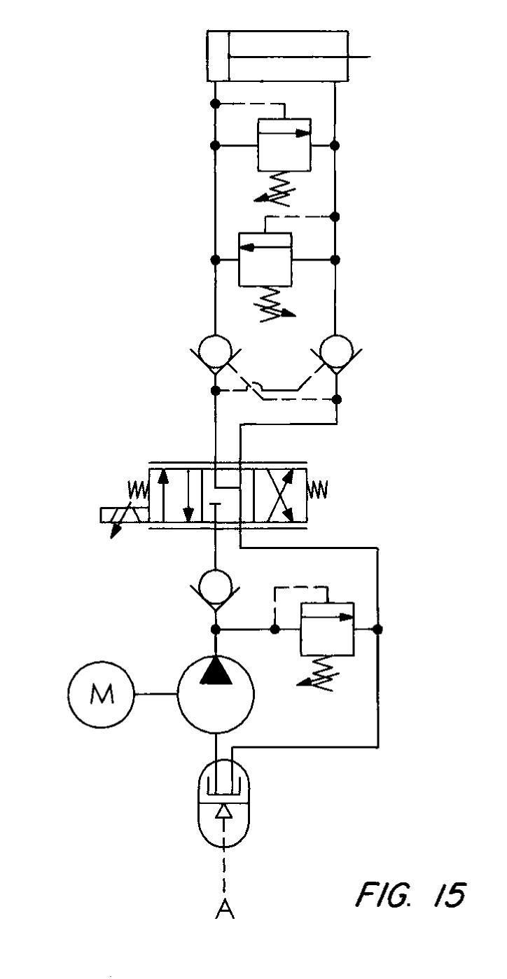

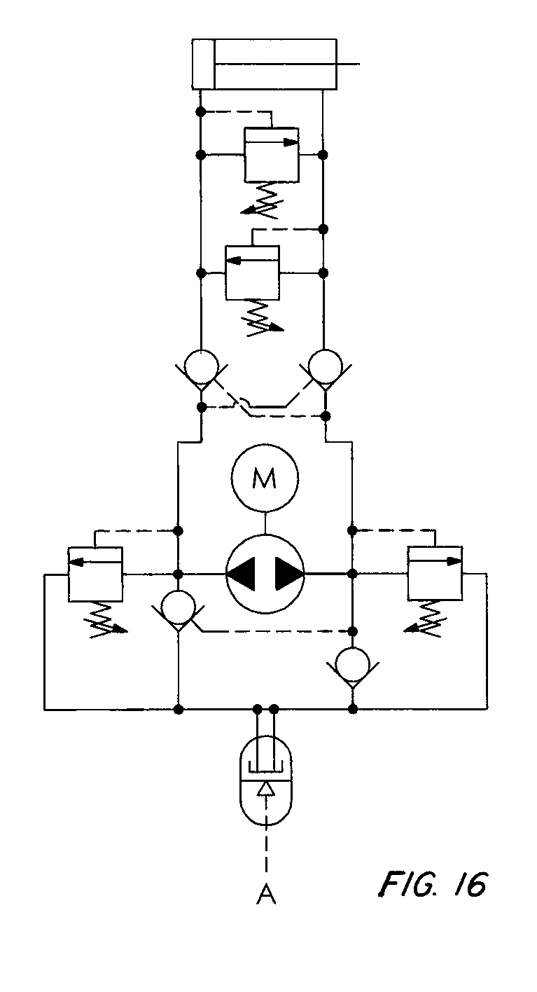

In a “power extend-power retract” configuration shown in FIG. 13-16, the motor 130 is on and the solenoid valve 170 is shifted accordingly, unless a bi-rotational motor 130 is used.

The present invention contemplates other types of both “lift-hold-lower” and “power extend-power retract” configurations known in the art. FIGS. 10-16 are exemplary circuits to be used with the invention, though other circuit configurations may be used.

As shown in FIG. 6, a metering device 630 can also be used to provide for reduced flow rate of returning fluid, and as returning fluid enters the reservoir 140, volume increases within one side of the linear actuator 110. This metering device 630 thus controls flow of fluid 1000 in said actuator system 100. The metering device 630 can further be a fixed or adjustable orifice that may be pressure compensated or part of the proportional valve design.

As previously discussed, the hydraulic system 100 comprises a control valve circuit. The control valve circuit may contain a combination of a metering, solenoid, relief, and check valves.

More specifically, the hydraulic system 100 can include a control valve circuit for single acting linear actuators including: a solenoid valve 170 to be normally open or closed when de-energized, a manual over-ride with detent options for the solenoid valve 170, metering 630 method for controlled retraction speed, valve size and/or selection for reduced flow restrictions and/or adjustability, check valve 610 at the pump outlet, and relief valve 620 for limiting system pressure.

The hydraulic system 100 can also include a control valve circuit for dual acting linear actuators including; a solenoid valve 170 that is either two or three position with various de-energized position configurations, manual over-ride with detent options for the solenoid controlled valve; load holding options that include the use of one or two pilot to open check valves, counterbalance valve, or a poppet type solenoid controlled valve; a metering method for controlled extension or retraction speed; a valve size and/or selection for reduced flow restrictions and/or adjustability; check valve at the pump outlet; relief valve for limiting system pressure; and use of a bi-rotational motor 130 versus a four way solenoid valve 170.

Poppet solenoid valve designs can be used for better load holding attributes of a positive seal. The valve can be a proportional design to meter fluid in one direction by means of controlled applied current that correlates to valve shift placement necessary for a desired amount of fluid to pass. Rated coil voltages, diode options, and terminal connections are also application dependant.

A counter balance valve is another commonly used method of load holding and generally used to prevent excessive actuator movement when gravity is a factor that affects speed control. This type of valve provides a positive seal, is normally closed, and requires a pilot pressure to open. Pilot pressure is taken off of the same side of the linear actuator and speed is metered. Force transmitted from pilot pressure must overcome an opposing spring force in order to open.

Furthermore, the hydraulic system contains fluid 1000 and the total volume of fluid 1000 is greater than the volume required to extend the actuator 110. When the actuator 110 is fully extended, the pressurized fluid opens a relief valve 620.

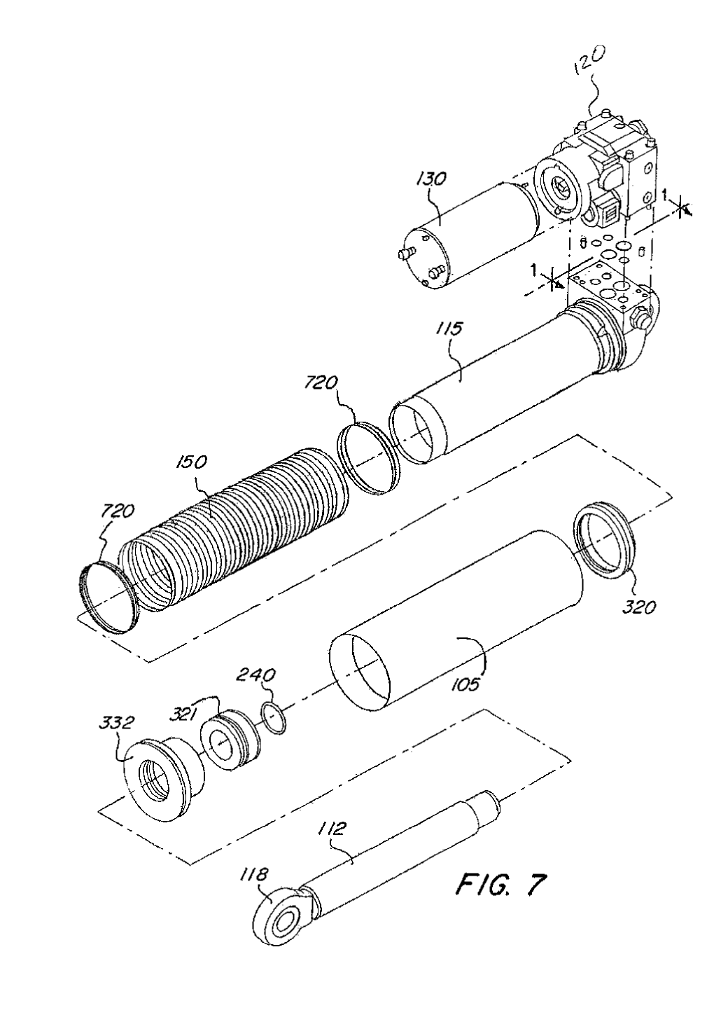

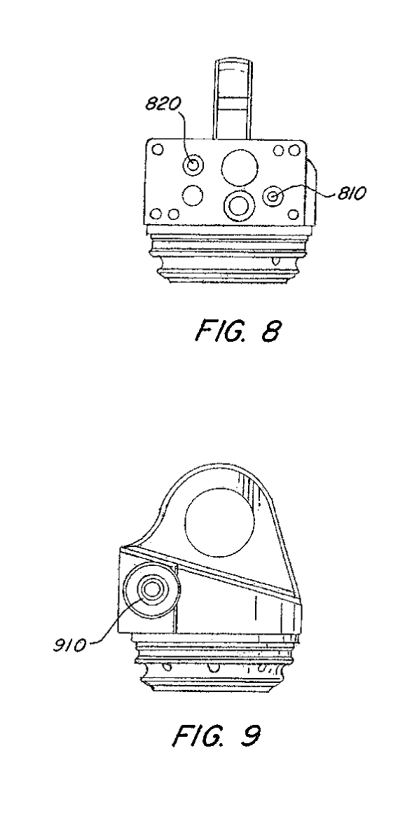

FIG. 7 shows an exploded view of the hydraulic system 100. Here, one can see the motor 130, pump 120, actuator tube 115, bladder 150, pilot ring 320, cylindrical cover 105, retaining ring 240, actuator rod 112, end-cap 332, and piston assembly 321. The figure demonstrates one embodiment and shows how the elements fit together and are linked with the other elements.

Further embodiments of the hydraulic system 100 pertain to hydraulic actuator systems of various mount configurations, seal configurations, geometry and materials. The hydraulic system 100 of the present invention has wear ring 220 geometry and materials for appropriate bearing loads, and works with pistons' of various diameter, length, and material. The actuator tube 115 may be provided with various diameters, lengths, wall thicknesses, and materials. The actuator rod 112 may be provided in various lengths, diameters, and materials for appropriate column strength. Embodiments can include a stop tube to addresses rod buckling, as well as cushions to minimize end of stroke speed and/or impact forces.

The present invention can also require various mounting configurations that are common to linear actuators 110 or are application unique. Options can include various brackets, clevis joints, flanges, lug and side mounts, thrust key, tie rod, or trunnion mounts, among others. Mounting classes common to the National Fluid Power Association (NFPA) include, but are not limited to: Class 1-Group 1 fixed mounts which absorb force on actuator centerline; Class 2-Group 2 pivot mounts which absorb force on actuator centerline; Class 1-Group 3 fixed mounts which do not absorb force on the actuator centerline. Other classes from the NFPA may also be used.

While the invention has been specifically described in connection with certain specific embodiments thereof, it is to be understood that this is by way of illustration and not of limitation and that various changes and modifications in form and details can be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. A hydraulic actuator system comprising:
a hydraulic actuator capable of moving under drive from hydraulic fluid;
a pump mounted to said hydraulic actuator for moving said hydraulic fluid;
a motor driving said hydraulic pump; and
a non-vented reservoir that provides fluid to expand said hydraulic actuator.

2. The hydraulic system of claim 1, wherein said reservoir is sealed air tight with combined volumes of said actuator and an expandable bladder surrounding said actuator.

3. The hydraulic system of claim 2, further comprising a cover around said bladder.

4. The hydraulic system of claim 2, wherein said bladder expands and contracts to minimize pressure changes in said reservoir.

5. The hydraulic system of claim 2, further comprising an atmospheric vent to enable bladder expansion and contraction.

6. The hydraulic system of claim 1, wherein said hydraulic actuator can retract either via gravity or via hydraulic fluid.

7. The hydraulic system of claim 1, wherein said reservoir is sealed air tight.

8. The hydraulic system of claim 1, wherein said reservoir is directly connected to the pump inlet.

9. The hydraulic system of claim 1, wherein said reservoir and lack of system air reduces oxidation of said hydraulic fluid.

10. The hydraulic system of claim 1, wherein said reservoir and lack of system air reduces cavitation in said hydraulic actuator.

11. The hydraulic system of claim 1, further comprising a control valve circuit.

12. The hydraulic system of claim 11, wherein said control valve circuit contains a combination of a solenoid valve, relief valve, and check valve in “lift-hold-lower” configuration.

13. The hydraulic system of claim 11, wherein said control valve circuit contains a combination of a solenoid valve, relief valve, and check valve in “power extend-power retract” configuration.

14. The hydraulic system of claim 1, wherein said system orientation is not dependent upon pump inlet position or external plumbing.

15. The hydraulic system of claim 1, further comprising a pump shaft seal vented to said reservoir.

16. The hydraulic system of claim 1, further comprising a metering device that controls the flow of fluid in said actuator.

17. The hydraulic system of claim 16, wherein said metering device is pressure compensated.

18. The hydraulic system of claim 16, wherein said metering device is part of a proportional valve design.

19. The hydraulic system of claim 16, wherein said metering device is a fixed orifice.

20. The hydraulic system of claim 16, wherein said metering device is an adjustable orifice.

21. The hydraulic system of claim 1, wherein the total volume of said hydraulic fluid is greater than the volume required to extend the actuator.

22. The hydraulic system of claim 21, wherein when said actuator is fully extended, said fluid opens a relief valve.

23. A hydraulic actuator system comprising:
a first housing comprising a motor and a pump connected to said motor;
a second housing comprising an actuator, a reservoir containing hydraulic fluid, and a control valve circuit,
wherein said reservoir is connected to said actuator via said control valve, and wherein said actuator is capable of moving in an axial direction parallel to the longitudinal axis of said second housing; and
wherein said first housing and second housing are attached by third housing.

24. The hydraulic system of claim 23, wherein said first housing is parallel to said second housing.

25. The hydraulic system of claim 23, wherein said reservoir is non-vented.

26. The hydraulic system of claim 23, wherein said reservoir is sealed air tight with combined volumes of said actuator and an expandable bladder surrounding said actuator.

27. The hydraulic system of claim 23, wherein said first housing and said second housing are cylindrical in shape.

28. The hydraulic system of claim 23, further comprising a control valve circuit that controls fluid flow throughout said system.
